(19) United States
(12) Patent Application Publication
(10) Pub. No.: US 2008/0007456 A1
(43) Pub. Date: Jan. 10, 2008

(54) Antenna structure and medium component for use in planar inverted-F antenna

(76) Inventors: Chin-Hao Chen, Taipei (TW); Chen-Ming Chiang, Taipei (TW); Chun-Chen Chao, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/648,588

(22) Filed: Jan. 3, 2007

(30) Foreign Application Priority Data
Jan. 4, 2006 (TW) 095200180

(51) Int. Cl. H01Q 1/38; H01Q 9/06

(52) U.S. Cl. 343/700 MS

(57) ABSTRACT

An antenna structure and a medium component for use in a planar inverted-F antenna are disclosed. The antenna structure comprises a radiation component, a ground component and a medium component. A space is between the radiation component and the ground component for generating resonance effects to transmit and to receive electromagnetic waves. The medium component is set into the space which is between the radiation component and the ground component for fastening the space, but also has insulation and waterproof functions. The efficacy for the antenna structure transmitting and receiving electromagnetic waves can be ensured.

### FIELD OF THE INVENTION

The present invention relates to an antenna structure and a medium for use in a planar inverted-F antenna, and more particularly to the medium component with a waterproof function applied to the antenna structure.

### BACKGROUND OF THE INVENTION

In regard to wireless communication function implemented by a portable electronic apparatus, the quality of an antenna may influence the communication quality of the portable electronic apparatus. Therefore, the design for the antenna is an important issue for the portable electronic apparatus. Generally speaking, the antenna includes a monopole antenna, a spiral antenna, a micro-strip antenna and a planar inverted-F antenna (PIFA). The planar inverted-F antenna can be hidden into the portable electronic apparatus. The impedance match is then reached without increasing inductances and capacitances, so that the planar inverted-F antenna is in widespread use. However, the components of an antenna may be influenced by an environment to change electrical characterization. The antenna may not receive and send electromagnetic waves smoothly to further influence the communication quality.

The inventor of the present invention based on years of experience on related research and development invents an antenna structure and a medium component for use in a planar inverted-F antenna to overcome foregoing shortcomings.

### SUMMARY OF THE INVENTION

Accordingly, the object of the present invention is to provide an antenna structure and a medium component for use in a planar inverted-F antenna. The medium component with waterproof function is applied in the antenna structure. Therefore, the communication quality may not be influenced when components of the antenna is influenced by an environment to change electrical characterization.

In accordance with the antenna structure of the present invention, the antenna structure includes a radiation component, a ground component, an electrically conductive element and a medium component. A space is between the radiation component and the ground component. The electrically conductive element is used to connect the radiation component and the ground component to form a short. The resonance effect is then generated to allow the antenna structure to receive and send electromagnetic waves. Moreover, the medium component is disposed in the space between the radiation component and the ground component. The medium component is not only used to fasten the space, but also has insulation and a waterproof function.

Additionally, another object of the present invention is to provide the medium component for use in the planar inverted-F antenna. The planar inverted-F antenna includes a radiation component, a ground component and an electrically conductive element. The radiation component and the ground component parallel with each other. A space is between the radiation component and the ground component. The electrically conductive element is used to connect the radiation component and the ground component to form a short. The resonance effect is then generated to allow the planar inverted-F antenna to receive and send electromagnetic waves. Furthermore, the medium component is disposed in the space between the radiation component and the ground component. The medium component is not only used to fasten the space, but also has insulation and a waterproof function. Because the medium component has the waterproof function, the dielectric constant may not be changed after the medium component absorbs wet. Alternatively oxidization may not occur when the radiation component and the ground component contact with the medium component. The electromagnetic waves received and sent by the antenna can be assured. Other features and advantages of the present invention and variations thereof will become apparent from the following description, drawings, and claims.

### BRIEF DESCRIPTION OF THE DRAWINGS

FIG. 1 is a schematic diagram illustrating an antenna structure according to an embodiment of the invention;

FIG. 2 is a schematic diagram illustrating an antenna structure assembled in a portable electronic apparatus according to a preferred embodiment of the present invention;

FIG. 3 is a perspective drawing illustrating a medium component for use in a planar inverted-F antenna according to an embodiment of the present invention; and

FIG. 4 is a side elevation illustrating a medium component for use in a planar inverted-F antenna according to an embodiment of the present invention.

### DETAILED DESCRIPTION OF THE PREFERRED EMBODIMENTS

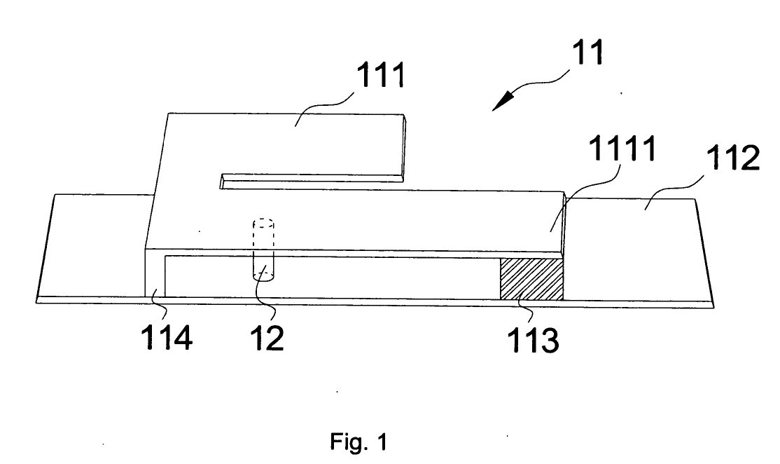

Referring to FIG. 1, a schematic diagram illustrates an antenna structure according to an embodiment of the present invention. The antenna structure 11 includes a radiation component 111, a ground component 112, an electrically conductive element 114 and a medium component 113. The radiation component 111 has electrical conductivity. A feed in unit 12 for signal feeding in is connected by the ground component 112. The electrically conductive element 114 is for connecting the radiation component 111 and the ground component 112 to form a short. An inductance is then generated between the feed in unit 12 and the electrically conductive element 114 for impedance matching the radiation component 111. Moreover, a distance is between the radiation component 111 and the ground component 112 in order to generate a capacitance. The antenna structure 11 then receives and sends electromagnetic waves through the resonant effect between the induction and the capacitance. Moreover, the medium component 113 is disposed in a space which is between the radiation component 111 and the ground component 112. The medium component 113 includes a first plane and a second plane. The first plane parallels the second plane. The first plane is connected to the radiation component 111. The second plane is connected to the ground component 112. A free-edge 1111 of the radiation component 111 being distant from the electrically conductive element 114 may cause drooping due to the weight of the free-edge 1111. The resonance effect may be further influenced. Therefore, the medium component 113 does not only have insulation and the waterproof function, but also supports the free-edge 1111 to fasten the space between the radiation component 111 and the ground component.

Furthermore, because the medium component 113 has the waterproof function, the drying can be kept so that the dielectric constant of the medium component 113 is not influenced by a humid environment. The medium component 113 contacts the radiation component 111 and the ground component 112 so that there is no oxidation occurred for the radiation component 111 and the ground component 112 due to the waterproof function. The efficiency of the antenna structure 11 could be assured at an optimal state.

The radiation component 111 and the ground component 112 are sheet metals and parallel each other. The electrically conductive element 114 can be a sheet metal or an extension arm from the radiation component 111. The feed in unit can be a coaxial wire. The medium component 113 is solidified silica gel.

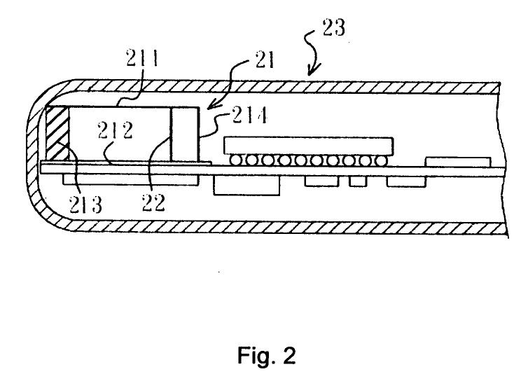

Referring to FIG. 2, a schematic diagram illustrates an antenna structure assembled in a portable electronic apparatus according to a preferred embodiment of the present invention. The antenna structure 21 includes a radiation sheet metal 211, a ground sheet metal 212 and solidified silica gel 213. The radiation sheet metal 211 parallels the ground sheet metal 212. A fixed distance is kept based on working frequencies of the antenna structure 21. The radiation sheet metal 211 is connected to a coaxial wire 22 which is for signal feeding through the ground sheet metal.212. The radiation sheet metal 211 extends an extension arm 214 near a signal feed in point. The extension arm 214 and the ground sheet metal 212 are formed a short. The coaxial wire 22 is electrically connected to the antenna structure 21 and the portable electronic apparatus 23. The solidified silica gel 213 can be used at −40° C.(centigrade)˜200° C. without deterioration. Meanwhile, hydrophobic material coated on a surface provides the waterproof function and also has slight flexibility and shock absorption. Therefore, the solidified silica gel 213 is connected to the radiation sheet metal 211 and the ground sheet metal 212 simultaneously to fasten and to protect the antenna structure 21. The efficiency for the antenna structure 21 receiving and sending electromagnetic waves can be assured.

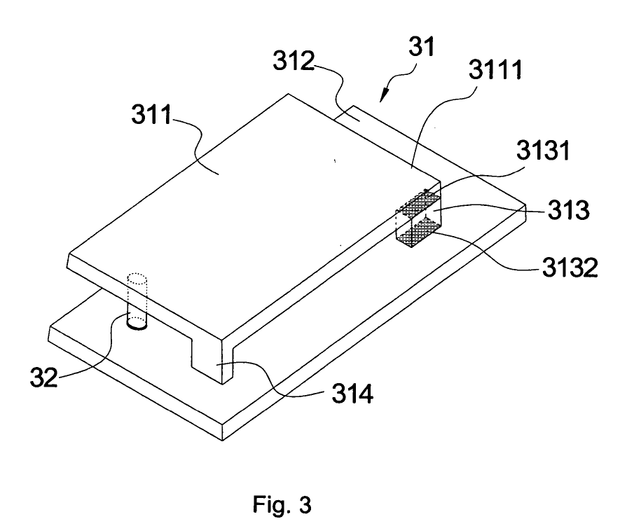

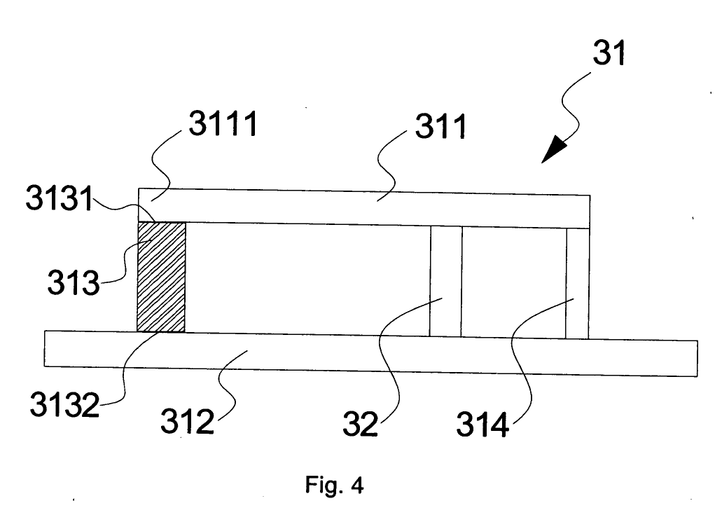

Referring to FIG. 3 and FIG. 4, a perspective drawing and a side elevation illustrate a medium component for use in a planar inverted-F antenna according to embodiments of the present invention. The planar inverted-F antenna 31 included a radiation component 311, an electrically conductive element 314 and a ground component 312. The planar inverted-F antenna 31 is electrically connected to a feed in unit 32. The radiation component 311 has electrical conductivity and is connected to the feed in unit 32 for signal feeding. The radiation component 311 is connected to the electrically conductive element 314 for forming a short with the ground component 312 which also has electrical conductivity. As shown in FIG. 4, a [symbol] -shape area is formed between the feed in unit 32 and the electrically conductive element 314 so as to generate an inductance for impedance matching the radiation component 311. The radiation component 311 parallels the ground component 312. Moreover, a distance is between the radiation component 311 and the ground component 312 to form a capacitance. The antenna structure 31 then receives and sends electromagnetic waves through the resonance effect between the inductance and the capacitance. The medium component 313 is disposed in a space which is between the radiation component 311 and the ground component 312. The medium component 313 includes a first plane 3131 and a second plane 3132. The first plane 3131 parallels the second plane 3132. The first plane 3131 is connected to the radiation component 311. The second plane 3132 is connected to the ground component 312. A free-edge 3111 of the radiation component 311 being distant from the electrically conductive element 314 may cause drooping, which may result in a non-uniform distance between the radiation component 311 and the ground component 312, and the radiation component 311 does not parallel the ground component 312. The resonance effect is further influenced. Therefore, the medium component 313 does not only have insulation and the waterproof functions; but also supports the free-edge 3111 to fasten the space between the radiation component 311 and the ground component 312.

Furthermore, because of the medium component 313 has the waterproof function, the drying can be kept so that the dielectric constant of the medium component 313 is not influenced by a humid environment. The medium component 313 contacts the radiation component 311 the ground component 312 so that there is no oxidation occurred for the radiation component 311 and the ground component 312 due to the waterproof function. The efficiency of the antenna structure could be assured at an optimal state.

Although the features and advantages of the embodiments according to the preferred invention are disclosed, it is not limited to the embodiments described above, but encompasses any and all modifications and changes within the spirit and scope of the following claims.

What is claimed is:

1. An antenna structure, comprising:
a ground component;
a radiation component, a space being between said radiation component and said ground component, said space allowed said antenna structure to receive and to send electromagnetic waves; and
at least one medium component disposed in said space to fasten said space, and said medium having a waterproof function.

2. The antenna structure of claim 1, wherein said antenna structure is connected to a feed in unit for signal feeding.

3. The antenna structure of claim 1, wherein said radiation component and said ground component have electrical conductivities respectively, and said radiation component and said ground component parallel each other for generating resonance effects to receive and to send electromagnetic waves.

4. The antenna structure of claim 1, wherein said radiation component and said ground component are sheet metals and parallel each other, and said sheet metals are for generating resonance effects to receive and to send electromagnetic waves.

5. The antenna structure of claim 1, wherein said antenna structure has an electrically conductive element for electrically connecting said radiation component and said ground component.

6. The antenna structure of claim 5, wherein said electrically conductive element is a sheet metal for electrically connecting said radiation component and said ground component.

7. The antenna structure of claim 5, wherein said radiation component has an extension arm, and said extension arm is taken to be said electrically conductive element.

8. The antenna structure of claim 1, wherein said medium component is an insulation material.

9. The antenna structure of claim 1, wherein said medium component has a surface with hydrophobic materials so as to provide said waterproof function.

10. The antenna structure of claim 1, wherein said medium component includes a first plane and a second plane, and said first plane parallels said second plane, and said first plane is connected to said radiation component, and said second plane is connected to said ground component.

11. A medium component for use in a planar inverted-F antenna, said planar inverted-F antenna comprising a radiation component and a ground component, a space being between said radiation component and said ground component, the characteristics in that:
a medium component being disposed in said space for fastening said space, and said medium component having a waterproof function.

12. The medium component of claim 11, wherein said planar inverted-F antenna is connected to a feed in unit for signal feeding.

13. The medium component of claim 11, wherein said radiation component and said ground component have conductivities respectively, and said radiation component and said ground component parallel each other for generating resonance effects to receive and to send electromagnetic waves.

14. The medium component of claim 11, wherein said radiation component and said ground component are sheet metals and parallel each other, and said sheet metals are for generating resonance effects to receive and to send electromagnetic waves.

15. The medium component of claim 11, wherein said planar inverted-F antenna includes an electrically conductive element for electrically connecting said radiation component and said ground component.

16. The medium component of claim 15, wherein said electrically conductive element is a sheet metal for electrically connecting said radiation component and said ground component.

17. The medium component of claim 15, wherein said radiation component has an extension arm, and said extension arm is taken to be said electrically conductive element.

18. The medium component of claim 11, wherein said medium component is an insulation material.

19. The medium component of claim 11, wherein said medium component has a surface with hydrophobic materials so as to provide said waterproof function.

20. The medium component of claim 11, wherein said medium component includes a first plane and a second plane, and said first plane parallels said second plane, and said first plane is connected to said radiation component, and said second plane is connected to said ground component.
